(19) United States
(12) Patent Application Publication
(10) Pub. No.: US 2026/0192945 A1
(43) Pub. Date: Jul. 9, 2026

(54) METHODS AND APPARATUS FOR DETERMINANT ASSEMBLY MANIPULATION

(71) Applicant: The Boeing Company, Arlington, VA (US)

(72) Inventor: Chester J. Hill, IV, Grafton, IL (US)

(21) Appl. No.: 19/012,509

(22) Filed: Jan. 7, 2025

(51) Int. Cl. B64F 5/10; B64F 5/50

(52) U.S. Cl. CPC B64F 5/10; B64F 5/50

(57) ABSTRACT

Methods and apparatus for determinant assembly manipulation are disclosed. A disclosed apparatus to manipulate a panel component for assembly thereof includes a cam rotatably coupled to a jig, the cam having a first interface portion, and a support frame to hold the panel component, the support frame having a second interface portion to contact the first interface portion in at least one rotational orientation of the cam.

### FIELD OF THE DISCLOSURE

This disclosure relates generally to tooling/manufacturing and, more particularly, to methods and apparatus for determinant assembly manipulation.

### BACKGROUND

For aircraft applications, parts and/or components can have a significant weight and size. For example, aircraft panels, such as those utilized in fuselage or wing sections, can be relatively large such that portions thereof can displace relative to another based on a weight distribution and a manner in which the panels are handled and/or constrained. In particular, known methods can necessitate a challenging precision hoist.

### SUMMARY

An example apparatus to manipulate a panel component for assembly thereof includes a cam rotatably coupled to a jig, the cam having a first interface portion, and a support frame to hold the panel component, the support frame having a second interface portion to contact the first interface portion in at least one rotational orientation of the cam.

An example cam of a support jig to manipulate a frame support for a vehicle component includes a body, a first rotational interface of the body, the first rotational interface to be rotatably coupled to the support jig, a second rotational interface of the body, the second rotational interface to be rotatably coupled to an actuator, and a contact interface of the body, the contact interface to contact the frame support to adjust a rotation thereof.

An example method of manipulating a support frame for carrying an aircraft panel component on a support jig includes placing the support frame onto the support jig to rotationally couple the support frame to the support jig, and rotating a cam rotationally coupled to the support frame to move the support frame.

### BRIEF DESCRIPTION OF THE DRAWINGS

FIG. 1 illustrates an example aircraft in which examples disclosed herein can be utilized for the manufacture thereof.

FIG. 2 illustrates an example manufacturing assembly in which examples disclosed herein can be implemented.

FIG. 3 illustrates a support frame of the example manufacturing assembly of FIG. 2 in a hoisting position.

FIGS. 4 and 5 are side views of the support frame of the example manufacturing assembly of FIGS. 2 and 3 in a hoisting position and a lowered position, respectively.

FIGS. 6A and 6B are detailed views of a portion of the example manufacturing assembly of FIGS. 2-5 in different rotational orientations.

FIGS. 7A and 7B illustrate an example restraint that can be implemented in examples disclosed herein.

FIGS. 8 and 9 illustrate alternative example restraints that can be implemented in examples disclosed herein.

FIG. 10 is a flowchart representative of an example method in accordance with teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for determinant assembly support are disclosed. In manufacturing environments, handling of a relatively large component in combination with its weight distribution can cause the component to warp and/or displace under the influence of gravity. For example, an aircraft fuselage panel can bend, warp and/or twist based on a distribution of weight over a relatively large distance. As a result, the panel can misalign to another component, such as a frame component and/or assembly. In turn, features of the panel can be difficult to align with corresponding features of the other component and, thus, assembly and/or handling thereof can be difficult. As a result, the component may necessitate reworking or may be rejected, thereby resulting in an increased repair and/or rework time, for example.

Examples disclosed herein are effective in mitigating the effects of gravity or other forces imparted on relatively large components such as skin panels, for example. Examples disclosed can enable more efficient and time-saving assembly of components by mitigating the effects of gravity or other forces that can adversely impact assembly of relatively large components. Examples disclosed herein can also reduce a need for setting up and/or updating tooling indexes by mitigating tolerance issues of relatively large components. While examples disclosed herein are described in the context of aircraft, examples disclosed herein can be applied to any other appropriate type of assembly and/or structure that is stationary or movable.

Examples disclosed herein support a frame (e.g., a support frame) that is releasably and/or rotatably couplable to a support jig/fixture (e.g., an assembly jig, a manufacturing jig, etc.) corresponding to a determinant assembly process. Examples disclosed herein utilize multiple holding devices, such as clamps, to carry and/or support a panel component (e.g., a vehicle panel, an aircraft panel, a fuselage panel, etc.). While the examples herein describe support of a panel component such as a skin panel, for example, it should be understood that the panel component may be an elongate workpiece, plate or other structure. According to some examples disclosed herein, multiple clamps are utilized to couple the panel component to the support frame, thereby reducing forces and/or distortions imparted to the panel component (e.g., forces due to gravity) while the panel component is being supported by the support frame. As a result, the part can be distorted and/or warped to an extent that can make it difficult to assemble other components thereto.

According to examples disclosed herein, the support frame is operatively and/or rotatably coupled to the aforementioned jig with a rotational joint. Examples disclosed herein utilize a cam (e.g., a cam mechanism, a cam device, a cam assembly, etc.) that is rotatably coupled to the jig to cause rotation and/or movement of the support frame. In particular, the cam includes a first interface portion to contact a second interface portion of the support frame in at least one orientation of the cam. The cam includes a first rotational interface to be rotatably coupled to the jig and a second rotational interface to be rotatably coupled to a movement/driving device.

According to some examples disclosed herein, the cam is rotationally/operatively coupled to an actuator (e.g., a hydraulic actuator, an electric actuator, etc.). In some examples, the cam has a generally triangular shape. In some examples, the cam includes a converging portion at or proximate the first interface portion. In some such examples, the converging portion includes a contact pad to contact the support frame. In some examples, a pin is utilized to restrict and/or prevent movement/rotation of the cam. Additionally or alternatively, a pin is utilized to restrain the support frame to the jig. In some such examples, the pin is movable and/or slidable within a ball and socket joint that is defined between the support frame and the jig.

As used herein, the term “cam” refers to an object, component and/or assembly that rotates to make contact with another part and impart a variable motion to the part. As used herein, the term “frame” can refer to any understructure, superstructure, side-supportive structure or a variation thereof utilized to support an object, structure and/or component.

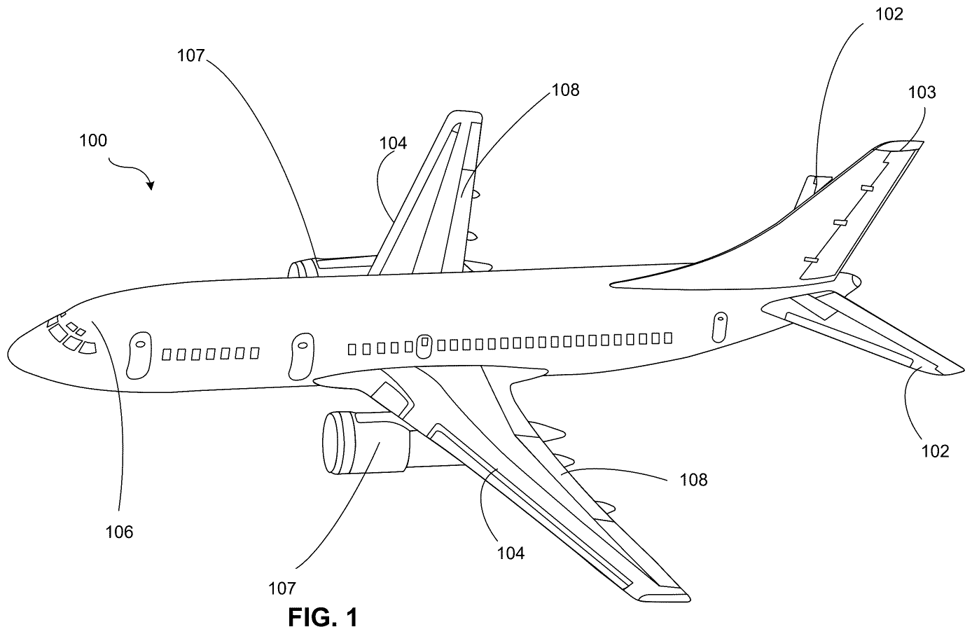

FIG. 1 illustrates an example aircraft 100 in which examples disclosed herein can be implemented. In particular, examples disclosed herein can be utilized to produce components and/or parts associated with the aircraft 100 and the subassemblies therein, for example. In the illustrated example of FIG. 1, the aircraft 100 includes horizontal tails 102, a vertical tail 103 and wings (e.g., fixed wings) 104 attached to a fuselage 106. The wings 104 of the illustrated example have engines 107, and control surfaces (e.g., flaps, ailerons, tabs, etc.) 108, some of which are located at a trailing edge or a leading edge of the wings 104. The control surfaces 108 may be displaced or adjusted (e.g., deflected, etc.) to provide lift during takeoff, landing and/or flight maneuvers.

In the illustrated example of FIG. 1, internal components and/or assemblies are located in the fuselage 106 (and other external components) of the aircraft 100. Examples disclosed herein can be applied to any appropriate internal or external structure and/or vehicle. Accordingly, examples disclosed herein can be utilized for rotorcraft, spacecraft, watercraft, submersibles, unmanned aerial vehicles, or stationary structures, etc. Examples disclosed herein can be utilized for any appropriate structure that can be adversely affected by gravity and/or distortions caused by gravity, for example. In a particular scenario, examples disclosed herein can effectively support a panel of the fuselage 106 and can reduce warpage and/or distortion thereof to facilitate assembly of frame components thereto. Examples disclosed herein can be applied to any of the horizontal tails 102, the vertical tail 103, the wings (e.g., fixed wings) 104, the fuselage 106, the engines 107, and the control surfaces (e.g., flaps, ailerons, tabs, etc.) 108 (or any other appropriate component of the aircraft 100).

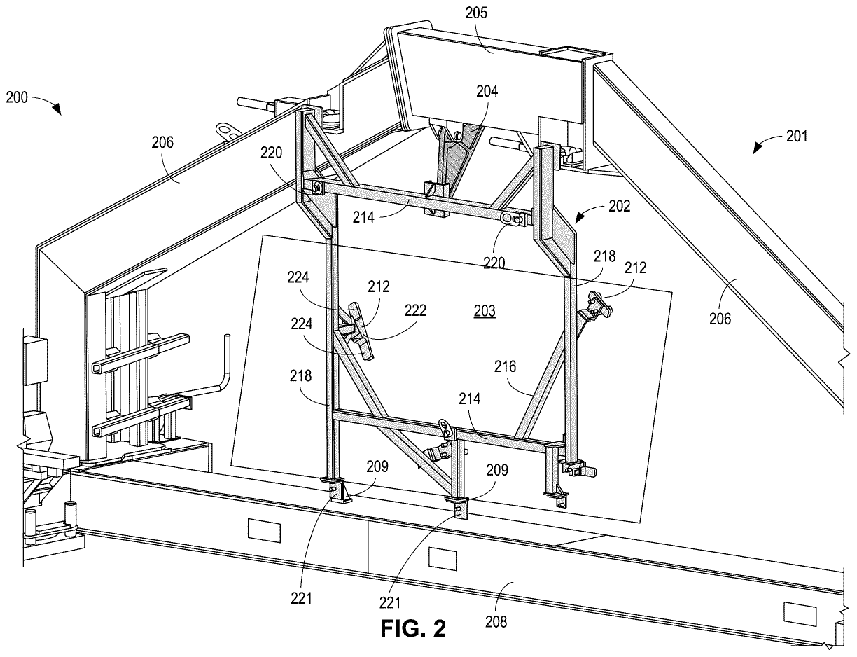

FIG. 2 illustrates an example manufacturing assembly 200 in which examples disclosed herein can be implemented. In particular, the example manufacturing assembly 200 is utilized to support an aircraft panel (e.g., a vehicle panel, an internal panel, an external panel, an aircraft skin, an aircraft fuselage panel, an exterior vehicle surface, a wing panel, a wing surface, a skin panel, an external panel, etc.) 203 and to aid in supporting the panel during assembly of individual frame sections of a frame structure of the aircraft 100 shown in FIG. 1. According to examples disclosed herein, the panel 203 can include a surface body (e.g., a curved planar body, a relatively flat planar body, etc.) with apertures for fastening subcomponents thereto.

In the illustrated example of FIG. 2, the example manufacturing assembly 200 includes an assembly jig (e.g., an assembly super structure, etc.) 201, a frame support 202 holding a panel 203, and a cam 204. The example assembly jig 201 includes a cross-brace 205, side supports 206 and a horizontal base 208 supporting tabs (e.g., stopping tabs) 209. The example manufacturing assembly 200 further includes a support frame 202 with holders (e.g., holding devices, clamps, clamping devices, etc.) 212, lateral beams 214, angled beams 216, side beams (e.g., arms) 218, retention hooks 220 and stops (e.g., tabs) 221. In the illustrated example of FIG. 2, the side beams 218 are on opposing sides of the cam 204. The example holders 212 are implemented as clamps (e.g., clamping elements) in this example and herein referred to as clamps. In this example, the clamps 212 include a body (e.g., a main body, a central body, a central portion, etc.) 222 with corresponding tabs 224 extending laterally therefrom.

According to examples disclosed herein, to secure the panel 203 to the support frame 202, the aforementioned tabs 224 can include apertures extending therethrough. In particular, a fastener (e.g., a pin, a locking pin, a hand knob, a clevis pin, a screw, a bolt, a nut, an insert, etc.) is placed through respective ones of the apertures of the tabs 224 to secure the panel 203 to the support frame 202. In this example, the apertures of the tabs 224 in conjunction with fastener to form a relatively tight nominal fit that enables a relatively precise part location. In this example, the clamps 212 include clamping portions/bodies that may be placed on opposite sides (e.g., opposite surfaces, interior and exterior surface, etc.) of the panel 203.

To prevent distortion of the panel 203, which can result in increased difficulty for assembly of subcomponents, at least one of the clamps 212 is enabled to move and/or displace via a slotted and/or oversized clearance interface. According to examples disclosed herein, the clamps 212 are arranged in opposing pairs such that each of the opposing pairs support a portion of the panel 203.

In this example, the support frame 202 is placed into the aforementioned assembly jig 201 such that the support frame 202 is rotationally coupled to the jig 201, thereby defining a rotational joint therebetween. In particular, the support frame 202 carrying the panel 203 can be lifted over to the jig 201 such that the support frame 202 is able to rotate about the rotational joint until the stops 221 contact a surface, feature and/or component of the jig 201. In some such examples, the support frame 202 can rotate under the influence of gravity until the stops 221 contact the supporting tabs (e.g., supporting stops) 209 of the jig 201 and the panel 203 is in a position and/or orientation (e.g., rotational orientation) such that forces imparted thereto are reduced and/or minimized. In other words, the panel 203 can be rotated via gravity upon the support frame 202 being rotationally coupled to the jig 201. Once the panel 203 is secured to the support frame 202 and the hoisted support frame 202 is coupled to the assembly jig 201 so that the assembly jig 201 bears the weight of the support frame 202, the panel 203 may be assembled relative to a vehicle frame structure without the weight of the attached support frame 202 imparting load to the panel 203 or causing distortion in the panel 203. As mentioned above, according to examples disclosed herein, individual components such as individual frame sections of a vehicle frame structure can be assembled to the panel 203 (and multiple panels together) when the panel 203 and the support frame 202 are supported by the assembly jig 201. For example, vehicle frame sections and components can be assembled to the panel 203. As previously indicated, the weight of a completely assembled frame structure may induce distortion or deflection across the length of frame sections such that apertures in the frame structure may no longer align with apertures in the panel 203, which could cause binding when attempting to install fasteners.

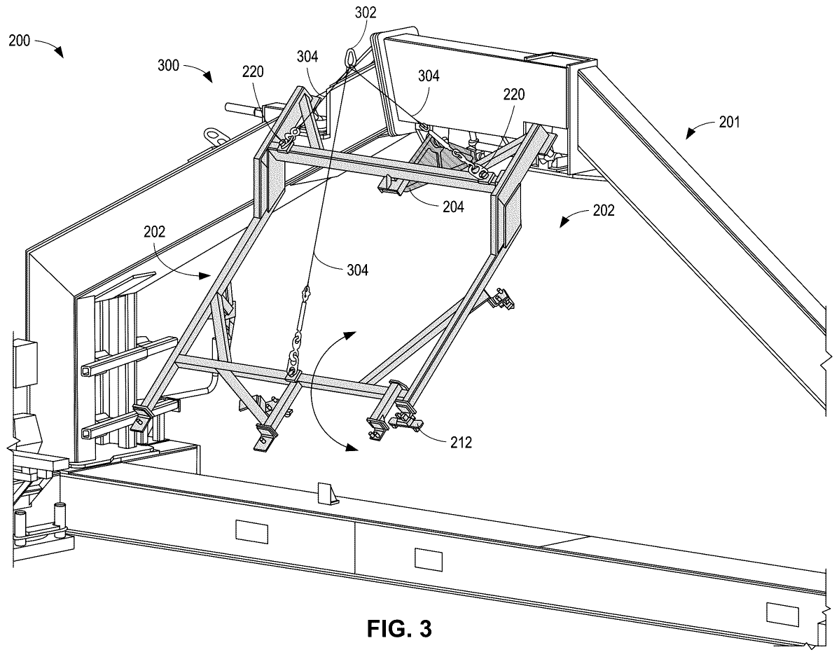

According to examples disclosed herein and as will be discussed below in connection with FIGS. 3-10, the cam 204 is rotated for manipulation of the support frame 202 and, in turn, the panel 203 or other object carried/supported by the support frame 202. To that end, the cam 204 is driven by an actuator other device/mechanism to contact and engage the support frame 202. In turn, the support frame 202 is manipulated with relative ease to an orientation for a manufacturing process, such as an assembly process for example.

FIG. 3 illustrates the support frame 202 of the example manufacturing assembly 200 in a hoisting position. According to examples disclosed herein, the support frame 202 is supported by a hoist (e.g., hoist equipment) 300 which, in turn, includes a hub 302 and at least one cable 304. In this example, the hooks 220 in combination with the at least one cable 304 are utilized to support and/or partially support the support frame 202 at an angle from the ground. According to some examples disclosed herein, the support frame 202 and the panel (not shown) secured via the clamps 212) is oriented at approximately 40 degrees (°) to 50° (e.g., 45°) from the ground. As a result, the support frame 202 along with the panel (not shown) can be lowered into the jig 201.

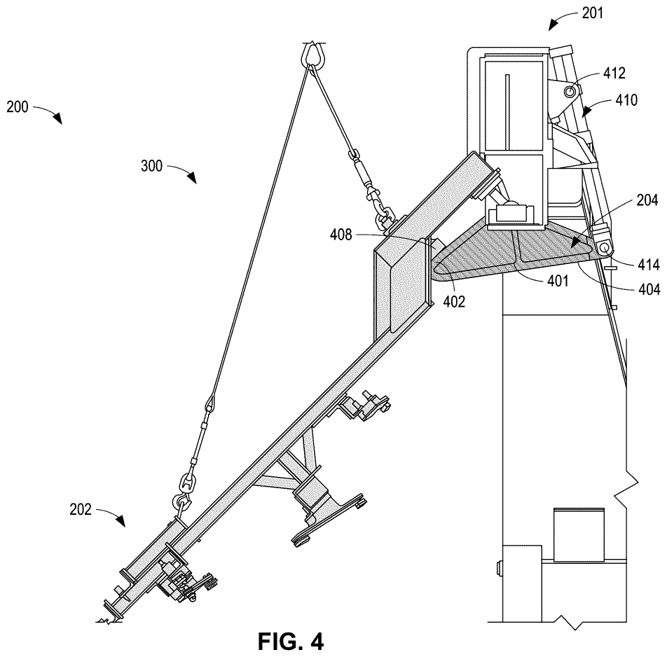

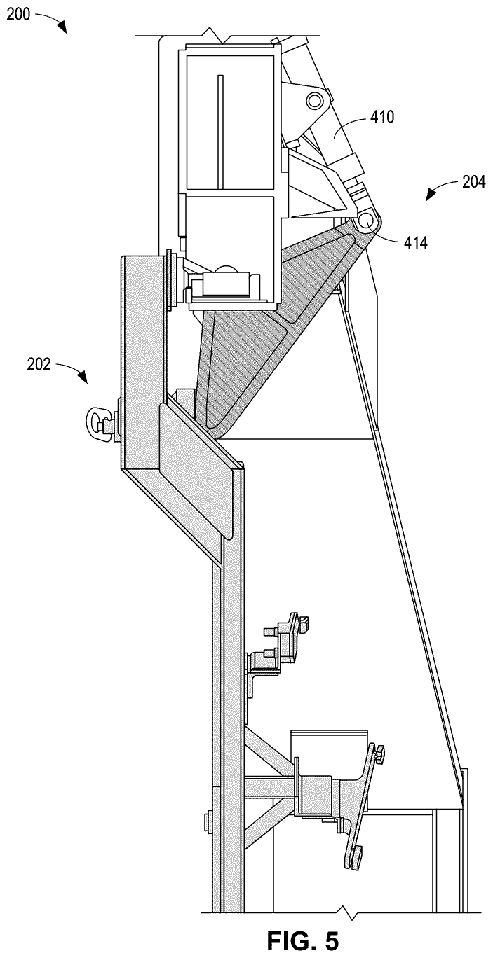

FIGS. 4 and 5 are side views of the support frame 202 of the example manufacturing assembly 200 of FIGS. 2 and 3 in a hoisting position and a lowered position, respectively. Turning to FIG. 4, the example cam 204 is shown orienting the support frame 202 to the depicted hoisted rotational orientation. In this example, the cam 204 includes a body 401, an interface portion (e.g., a contact portion, etc.) 402, and a driving portion 404. The cam 204 of the illustrated example exhibits a generally triangular shape. In particular, the contact portion 402 is positioned at or proximate a corner/vertex/converging portion of the triangular shape. According to some examples disclosed herein, a rotational joint/pivot of the cam 204 with respect to the jig 201 is positioned at or proximate another corner/vertex/converging portion of the triangular shape. In this example, the corners/vertices/converging portions are separated by relatively straight edges (e.g., on opposite sides of a pivot of the cam 204). However, any other shape and/or kinematic relationship can be implemented instead.

To support the support frame 202, the example cam 204 includes the interface portion 402 to contact and engage an interface portion 408 of the support frame 202. In this example, the contact portion 402 defines a relatively flat surface to contact a corresponding relatively flat surface of the aforementioned interface portion 402. In some examples, a compressible material and/or pad is used in/on the interface portion 402 to prevent wear and/or provide a dampening action for motion of the support frame 202 relative to the jig 201.

According to examples disclosed herein, to rotate the cam 204, an actuator (e.g., a hydraulic actuator, a power actuator, etc.) 410 is implemented to control movement of the cam 204 and, in turn, an orientation of the support frame 202. In this example, the actuator 410 is supported by the jig 201 at a rotational joint 412. Further, the example actuator 410 can cause movement of the aforementioned driving portion 404 of the cam 204 via a rotational joint (e.g., a rotational interface) 414 based on changing a length thereof. In other words, controlling a length (e.g., an extension length) of the actuator 410 causes rotation of the cam 204 and, thus, the support frame 202.

FIG. 5 depicts the support frame 202 in a lowered position. In contrast to the view shown in FIG. 4, the actuator 410 has moved to a retracted state, thereby causing and/or enabling the cam 204 to rotate the support frame 202 to the aforementioned lowered position. In the illustrated example of FIG. 5, the movement and/or retraction of the actuator 410 vertically raises the rotational joint 414 (in the view of FIG. 5), thereby causing the support frame 202 to rotate down toward the ground.

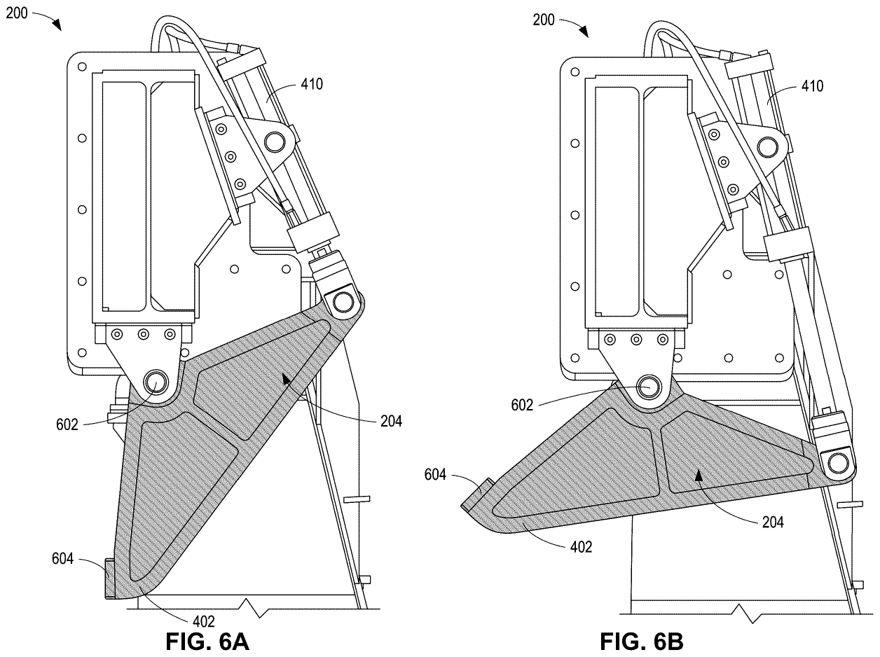

FIGS. 6A and 6B are detailed views of a portion of the example manufacturing assembly 200 of FIGS. 2-5 in different rotational orientations. Turning to FIG. 6A, the example cam 204 is shown rotated by the actuator 410 about a rotational joint (e.g., a rotational interface, a pivot, a pivoting joint, etc.) 602. As a result, a contact (e.g., a contact portion, a contact interface, etc.) 604 of the interface portion 402 of the cam 204 is positioned to orient the support frame 202 shown in FIGS. 2-5 in a relatively vertical orientation (in the view of FIG. 6A). In this example, the contact 604 defines a relatively flat surface to contact a corresponding relatively flat surface of the support frame 202 of FIGS. 2-5.

FIG. 6B depicts the cam 204 in a rotational orientation that is a result of the actuator 410 being controlled to the extended position. Accordingly, based on the cam 204 being rotated about the rotational joint 602 to the orientation shown in FIG. 6B, the contact 604 of the interface portion 402 is raised, thereby orienting the support frame 202 shown in FIGS. 2-5 in an angled rotational orientation.

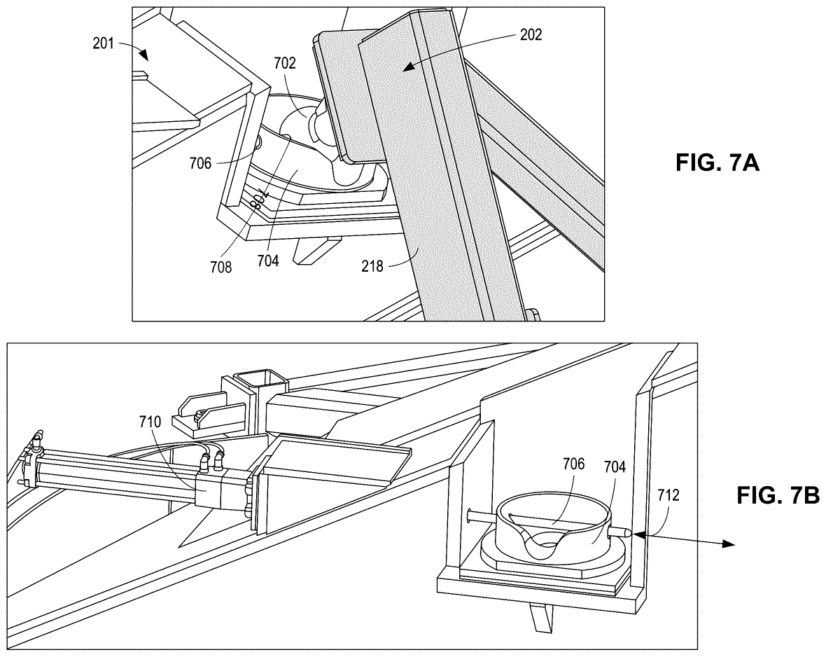

FIGS. 7A and 7B illustrate an example restraint that can be implemented in examples disclosed herein. Turning to FIG. 7A, a detailed view of an example rotational joint defined between the support frame 202 and the assembly jig 201 is shown. In the illustrated example of FIG. 7A, the side bar 218 of the support frame 202 is shown with a ball 702 while the jig 201 has a corresponding socket 704, which may be conical in shape, thereby defining a ball joint therebetween. Further, a pin 706 is utilized to retain the ball 702 and, thus, the support frame 202 to the jig 201. In this example, the ball 702 has an aperture of 708 extending therethrough to receive the pin 706. Accordingly, the pin 706 can be moved (e.g., translated, moved in a linear fashion) in and out of the aperture 708 to secure and/or restrain the ball 702 and, thus, the support frame 202 to the jig 201.

FIG. 7B depicts the rotational joint of FIG. 7A, but with the support frame 202 and the ball 702 removed for clarity. In the illustrated example, the pin 706 can be moved by an actuator 710 in directions generally indicated by a double arrow 712. In the illustrated example of FIG. 7B, the actuator 710 displaces the pin 706 to move through apertures of the socket 704 as well as the aperture 708 of the ball 702 shown in FIG. 7A. In some examples, the pin 706 is automatically caused to move within the aperture 708 of the ball 702 and the socket 704 when a presence of the support frame 202 is detected (e.g., based on sensor information, based on a switch position, etc.).

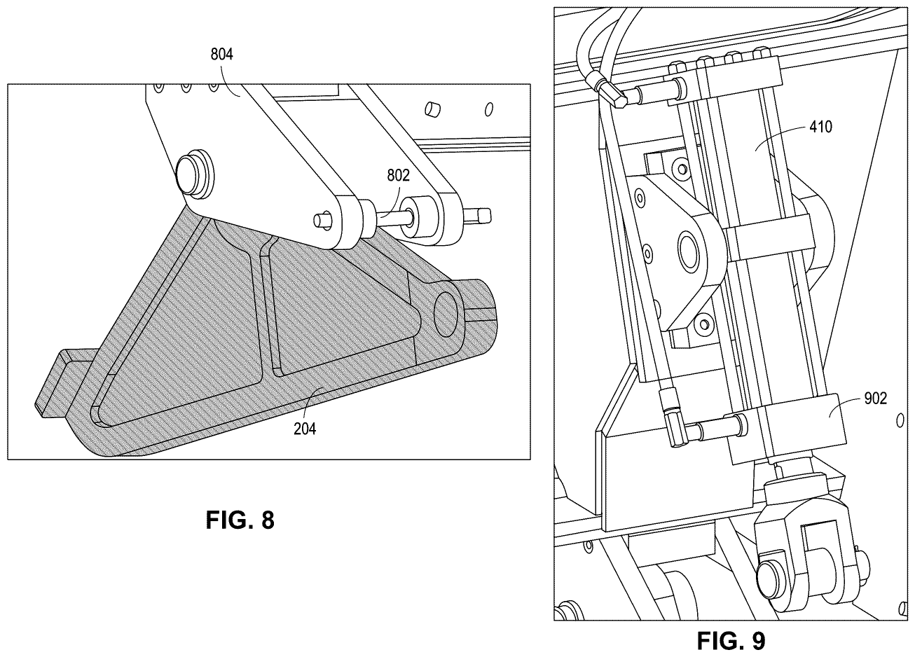

FIGS. 8 and 9 illustrate alternative example restraints that can be implemented in examples disclosed herein. FIG. 8 depicts a restraining pin 802 that can be held by a bracket 804 of the support frame 202. According to examples disclosed herein, the restraining pin 802 limits and/or prevents rotational motion of the cam 204. As a result, the cam 204 can be prevented from at least one rotational range and/or orientation in certain scenarios (an actuator disconnection, an actuator not present, etc.). Additionally or alternatively, a tether line attached to the cam 204 is utilized to restrict angular motion thereof.

FIG. 9 depicts a velocity fuse 902 that can be implemented in examples disclosed herein to limit and/or control movement of the actuator 410. According to examples disclosed herein, the velocity fuse 902 can prevent rapid displacement and/or operation of the actuator 410.

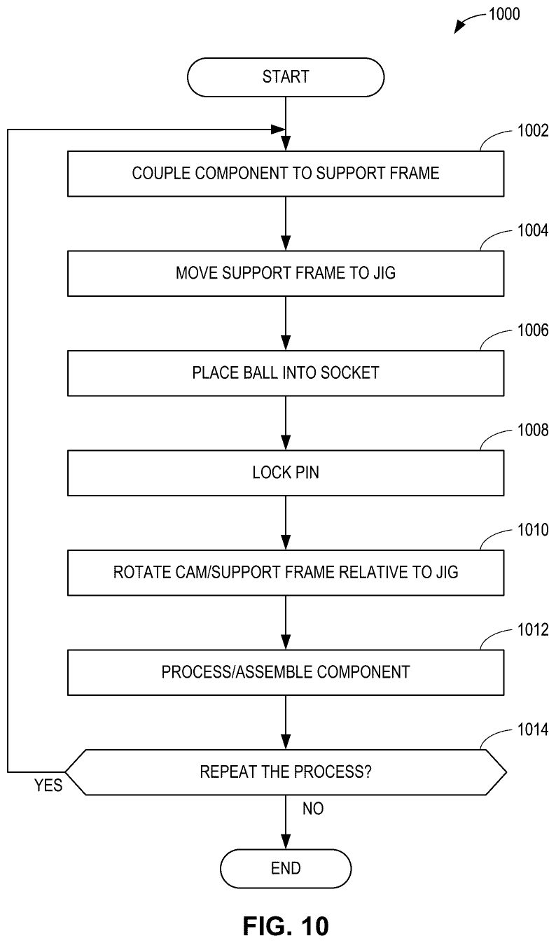

FIG. 10 is a flowchart representative of an example method 1000 in accordance with teachings of this disclosure. The example method 1000 is utilized for manipulating a panel during a manufacturing process and begins as a component, which is a vehicle panel (e.g., a fuselage panel for an aircraft, an aircraft panel, an aircraft skin surface, etc.) in this example, is to be supported for assembly of subcomponents (e.g., frame subcomponents) thereto. At block 1002, an example panel component/workpiece is coupled to and/or placed on a support frame (e.g., the support frame 202) via clamps (e.g., the clamps 212). In this example, at least one pair of opposing clamps is utilized to carry and/or support the vehicle panel with a compressible material.

At block 1004, according to examples disclosed herein, the support frame is coupled to an assembly jig (e.g., the jig 201). In this example, the support frame is rotationally coupled to the assembly jig.

At block 1006, at least one ball (e.g., a ball end, a ball pin, etc.) of the support frame is placed into a socket of the jig. In the illustrated example, the ball is inserted into a conical section of the socket and the ball is guided with respect to the conical section to align the support frame relative to the assembly jig. In this example, two of the balls are utilized such that the balls are laterally spaced across the support frame. In some examples, a pin is moved and/or actuated to at least one of the balls, thereby constraining the support frame to the jig.

At block 1008, a pin is placed in the jig to constrain the support frame relative to the assembly jig. In this example, the pin is utilized to prevent the support frame from rotating to at least one angular orientation.

At block 1010, the support frame is rotated, moved and/or oriented once coupled to the assembly jig due to movement/rotation of the cam. In this example, the support frame is rotated based on an actuator (e.g., a hydraulic actuator) causing rotation of the cam. In some examples, the support frame can be rotated under the influence of gravity until the cam contacts the support frame.

At block 1012, additional frame section components and/or sub-frame components are assembled to the vehicle panel. In this example, frame sections and components are assembled to the vehicle panel, as well as other frame components.

At block 1014, it is determined whether to repeat the process. If the process is to be repeated (block 1014), control of the process returns to block 1002. Otherwise, the process ends. This determination may be based on whether additional panels are to be assembled with components and/or subcomponents.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to enable effective manipulation of support frames for vehicle panels are disclosed herein. Further examples and combinations thereof include the following:

Example 1 includes an apparatus to manipulate a panel component for assembly thereof, the apparatus comprising a cam rotatably coupled to a jig, the cam having a first interface portion, and a support frame to hold the panel component, the support frame having a second interface portion to contact the first interface portion in at least one rotational orientation of the cam.

Example 2 includes the apparatus as defined in example 1, wherein the support frame is rotationally coupled to the jig.

Example 3 includes the apparatus as defined in example 2, wherein arms of the support frame are rotationally coupled to the jig on opposing sides of the cam.

Example 4 includes the apparatus as defined in example 1, wherein the cam is rotationally coupled to the jig at a first rotational joint, and wherein the cam is rotationally coupled to an actuator at a second rotational joint that is spaced apart from the first rotational joint.

Example 5 includes the apparatus as defined in example 1, wherein the cam includes a converging portion at the first interface portion.

Example 6 includes the apparatus as defined in example 5, wherein the converging portion is adjacent a straight edge.

Example 7 includes the apparatus as defined in example 5, wherein the converging portion is a first converging portion, and wherein the cam includes a second converging portion on an opposite side of the first converging portion, the second converging portion rotationally coupled to an actuator.

Example 8 includes the apparatus as defined in example 1, further including a contact pad on the first interface portion.

Example 9 includes the apparatus as defined in example 1, wherein the support frame and the jig define a ball and socket joint therebetween, and further including a movable pin to constrain the ball to the socket.

Example 10 includes a cam of a support jig to manipulate a frame support for a vehicle component, the cam comprising a body, a first rotational interface of the body, the first rotational interface to be rotatably coupled to the support jig, a second rotational interface of the body, the second rotational interface to be rotatably coupled to an actuator, and a contact interface of the body, the contact interface to contact the frame support to adjust a rotation thereof.

Example 11 includes the cam as defined in example 10, wherein the body has a triangular shape.

Example 12 includes the cam as defined in example 11, wherein the second rotational interface is on a vertex of the triangular shape.

Example 13 includes the cam as defined in example 12, wherein the vertex is a first vertex, and wherein the first rotational interface is on a second vertex of the triangular shape.
Example 14 includes the cam as defined in example 10, wherein the contact interface and the second rotational interface are on opposing sides of the first rotational interface.

Example 15 includes a method of manipulating a support frame for carrying an aircraft panel component on a support jig, the method comprising placing the support frame onto the support jig to rotationally couple the support frame to the support jig, and rotating a cam rotationally coupled to the support frame to move the support frame.

Example 16 includes the method as defined in example 15, further including moving a pin at a rotational joint defined between the support frame and the support jig to restrain the support frame to the support jig.

Example 17 includes the method as defined in example 16, wherein the pin is moved into a first aperture of a ball and a second aperture of a socket, the ball and socket defining a rotational interface between the support jig and the support frame.

Example 18 includes the method as defined in example 15, wherein the cam is rotated until a contact pad of the cam engages the support frame.

Example 19 includes the method as defined in example 15, wherein the cam is rotated while the support frame is hoisted.

Example 20 includes the method as defined in example 15, wherein rotating the cam includes moving a converging portion of the cam to contact and engage the support frame.

From the foregoing, it will be appreciated that example systems, apparatus, articles of manufacture, and methods have been disclosed that enable effective manipulation of vehicle panels.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to manipulate a panel component for assembly thereof, the apparatus comprising:
a cam rotatably coupled to a jig, the cam having a first interface portion; and
a support frame to hold the panel component, the support frame having a second interface portion to contact the first interface portion in at least one rotational orientation of the cam.

2. The apparatus as defined in claim 1, wherein the support frame is rotationally coupled to the jig.

3. The apparatus as defined in claim 2, wherein arms of the support frame are rotationally coupled to the jig on opposing sides of the cam.

4. The apparatus as defined in claim 1, wherein the cam is rotationally coupled to the jig at a first rotational joint, and wherein the cam is rotationally coupled to an actuator at a second rotational joint that is spaced apart from the first rotational joint.

5. The apparatus as defined in claim 1, wherein the cam includes a converging portion at the first interface portion.

6. The apparatus as defined in claim 5, wherein the converging portion is adjacent a straight edge.

7. The apparatus as defined in claim 5, wherein the converging portion is a first converging portion, and wherein the cam includes a second converging portion on an opposite side of the first converging portion, the second converging portion rotationally coupled to an actuator.

8. The apparatus as defined in claim 1, further including a contact pad on the first interface portion.

9. The apparatus as defined in claim 1, wherein the support frame and the jig define a ball and socket joint therebetween, and further including a movable pin to constrain the ball to the socket.

10. A cam of a support jig to manipulate a frame support for a vehicle frame component, the cam comprising:
a body;
a first rotational interface of the body, the first rotational interface to be rotatably coupled to the support jig;
a second rotational interface of the body, the second rotational interface to be rotatably coupled to an actuator; and
a contact interface of the body, the contact interface to contact the frame support to adjust a rotation thereof.

11. The cam as defined in claim 10, wherein the body exhibits a triangular shape.

12. The cam as defined in claim 11, wherein the second rotational interface is on a vertex of the triangular shape.

13. The cam as defined in claim 12, wherein the vertex is a first vertex, and wherein the first rotational interface is on a second vertex of the triangular shape.

14. The cam as defined in claim 10, wherein the contact interface and the second rotational interface are on opposing sides of the first rotational interface.

15. A method of manipulating a support frame for carrying an aircraft panel component to a support jig, the method comprising:
placing the support frame onto the support jig to rotationally couple the support frame to the support jig; and
rotating a cam rotationally coupled to the support frame to move the support frame.

16. The method as defined in claim 15, further including moving a pin at a rotational joint defined between the support frame and the support jig to restrain the support frame to the support jig.

17. The method as defined in claim 16, wherein the pin is moved into a first aperture of a ball and a second aperture of a socket, the ball and socket defining a rotational interface between the support jig and the support frame.

18. The method as defined in claim 15, wherein the cam is rotated until a contact pad of the cam engages the support frame.

19. The method as defined in claim 15, wherein the cam is rotated while the support frame is hoisted.

20. The method as defined in claim 15, wherein rotating the cam includes moving a converging portion of the cam to contact and engage the support frame.
